(19) United States
(12) Patent Application Publication
(10) Pub. No.: US 2008/0300852 A1
(43) Pub. Date: Dec. 4, 2008

(54) Multi-Lingual Conference Call

(76) Inventors: David Johnson, Emsworth (GB); Anthony Waters, Maidenhead (GB)

Correspondence Address: BARNES & THORNBURG LLP, P.O. BOX 2786, CHICAGO, IL, 60690-2786, US

(21) Appl. No.: 11/755,205

(22) Filed: May 30, 2007

(51) Int. Cl. G06F 17/28

(52) U.S. Cl. 704/2

(57) ABSTRACT

The present invention relates to apparatus arranged to facilitate translation of speech within a conference call. The apparatus receives speech data in a first language, converts the speech data in the first language into meta-data; and the meta-data is then translated into speech data in a second language. The apparatus may be distributed across a network or situated on a single node in the network.

### FIELD OF THE INVENTION

This invention relates to apparatus and methods for enabling multiple spoken languages to be used in a conference call.

### BACKGROUND OF THE INVENTION

When a conference call is made, all the terminals in the conference call are connected to a conference bridge. The conference bridge receives all data transmitted by the terminals within the conference, processes the data and transmits it to all terminals connected to the conference. In a conventional conference call the conference bridge may be one of the terminals or, alternatively, may be a separate node in the network adapted to act as a conference bridge.

As the conference call bridge only receives, repackages and retransmits the received data, all speech data is transmitted in the language in which it is received. This means that conference calls are held in a single language. This can be a problem in, for example, multinational companies where conference calls are held between people in different countries. In this instance some users at terminals connected to the conference bridge will have to listen and speak in a language that is not their mother tongue, which may result in misunderstandings.

Hence, speech data may be translated before it is broadcast by terminals used by the users speaking in a different language. However, multiple problems arise when implementing translation of languages within a conference call. For example, the transmission of data through a network must be controlled to ensure that the time required to translate does not result in data being received by two terminals connected to the conference at separate times.

### SUMMARY OF THE INVENTION

In accordance with a first aspect of the present invention there is provided apparatus in a network comprising a speech receiver to receive speech data in a first language from a transmitter, first translation means to translate the received speech data to meta data, a data transmitter to transmit meta data to the network, a meta data receiver to receive meta data from the network second translation means to translate meta data to speech data in the first language and a speech transmitter to transmit data to a receiver unit.

Preferably, the speech data is provided with source information. The source information may include an identifier comprising at least one of the group comprising a language identity of the language of the speech data as received at the speech receiver and a user terminal identity for the user terminal from which speech data is received by the apparatus.

If the identifier is a language identity, then the apparatus may further include identification means arranged to determine if the first language is the language identification using the language identity. Advantageously, the identification means causes the apparatus to discard the meta data if the language identified in the language identify is the same as the first language.

Optionally, the apparatus may include memory to store speech data received by the speech receiver. The apparatus may then cause the speech transmitter to transmit the speech data stored in the memory to user terminals connected to the apparatus. The identifier may further include user terminal id for the user terminal from which a speech receiver received speech data; the apparatus being arranged to not transmit speech data to a user terminal from which the speech data was received.

Preferably, the meta-data is provided with timing information such that the speech transmitter transmits speech data at a predetermined time.

Optionally, the apparatus may include conversion means arranged to convert the meta data to intermediate meta data and transmits the intermediate meta data to the network.

Preferably, the apparatus further comprises means for receiving, from a user at a user terminal, a connection request including a language identifier and is arranged to determine whether the identified language is the first language.

Preferably, the apparatus may be arranged to receive speech data from a user terminal associated with the first language. If the identified language is not the first language, the preferably, the apparatus connects to a second apparatus, the second apparatus comprising a speech receiver to receive speech data in a second language from a transmitter, first translation means to translate the received speech data to meta data, a data transmitter to transmit meta data to the network, a meta data receiver to receive meta data from the network, second translation means to translate meta data to speech data in the second language and a speech transmitter for transmitting data to a receiver unit.

Preferably, the second apparatus is arranged to transmit meta-data to the first apparatus. Alternatively, the second apparatus may be arranged to transmit meta data to a conference bridge.

The apparatus preferably further includes receiving means to receive transmission data from a database arranged to store translation data associated with a user terminal id for translating speech data received from a user terminal to the meta-data. Advantageously, the translation data is retrieved from the database when a user terminal having a user id connects to the apparatus.

The meta-data is preferably text.

According to a further aspect of the present invention there is provided a network including a first and second apparatus, each apparatus including a speech receiver to receive speech data in a first language from a transmitter, first translation means to translate the received speech data to meta data, a data transmitter to transmit meta data to the network, a meta data receiver to receive meta data from the network second translation means to translate meta data to speech data in the first language and a speech transmitter to transmit data to a receiver unit. The first apparatus being for a first language and the second apparatus being for a second language. The first and second apparatus may be conference bridges.

The network may further include a third apparatus including a speech receiver to receive speech data in a first language from a transmitter, first translation means to translate the received speech data to meta data, a data transmitter to transmit meta data to the network, a meta data receiver to receive meta data from the network second translation means to translate meta data to speech data in the first language and a speech transmitter to transmit data to a receiver unit. The third apparatus may also be a conference bridge.

Alternatively the first and second apparatus are translation engines. The network may include a conference bridge to which the first and second translation engines are connected. Preferably, the conference bridge is arranged to transmit meta-data to the translation engines.

Optionally, the conference bridge may be arranged to translate the meta-data into intermediate meta-data before transmitting it to the translation engine connected to it. Alternatively, the first translation engine may be arranged to translate the meta-data form to an intermediate meta-data form before transmitting it to the conference bridge.

The meta-data may be text data. If the meta data is text data then the text data may be translated from the first language to the second language prior to converting the text data to speech data.

According to another aspect of the present invention there is provided a method of translating speech comprising receiving speech data in a first language from a transmitter, translating the received speech data to meta data, transmitting meta data to a network, receiving meta data from the network, translating meta data to speech data in the first language and transmitting data to a receiver unit.

According to a further aspect of the present invention there is provided a computer programme arranged to cause apparatus to carry out the steps of receive speech data in a first language from a transmitter, translate the received speech data to meta data, transmit meta data to a network, receive meta data from the network, translate meta data to speech data in the first language and transmitting data to a receiver unit.

### BRIEF DESCRIPTION OF THE DRAWINGS

Other aspects and features of the present invention will become apparent to those ordinarily skilled in the art upon review of the following description of specific embodiments of the invention in conjunction with the accompanying figures.

FIG. 1 is a flow chart illustrating the set up of a conference call;

FIG. 2 is a diagrammatic illustration of a network in accordance with a first embodiment of the invention;

FIG. 3 is a flow chart illustrating the flow of messages during a conference call in the network of a first embodiment of the invention;

FIG. 4 is a diagrammatic illustration of a network in accordance with a second embodiment of the invention; and

FIG. 5 is a diagrammatic illustration of a network in accordance with a third embodiment of the invention.

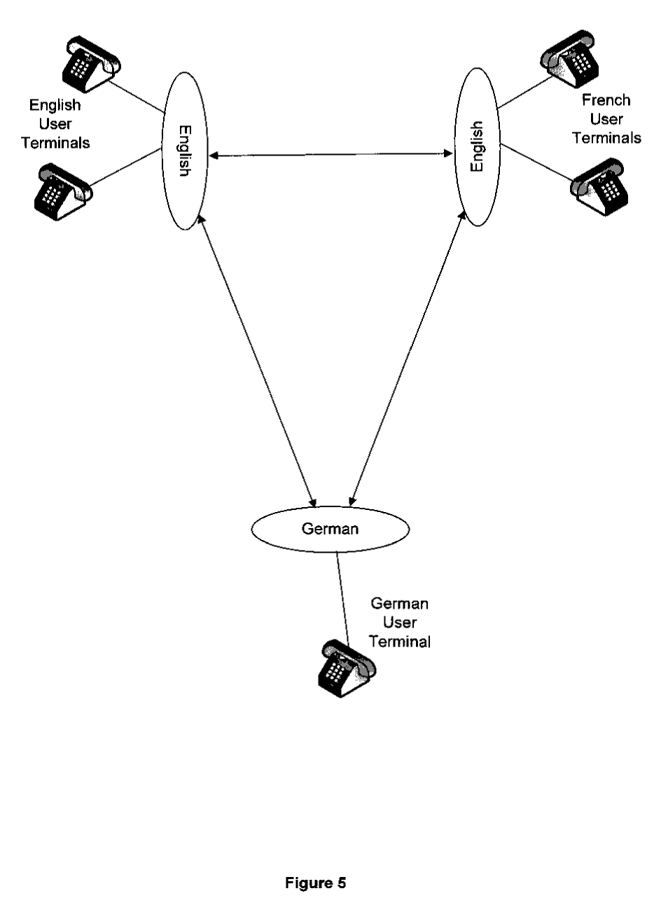

### DETAILED DESCRIPTION OF PREFERRED EMBODIMENTS

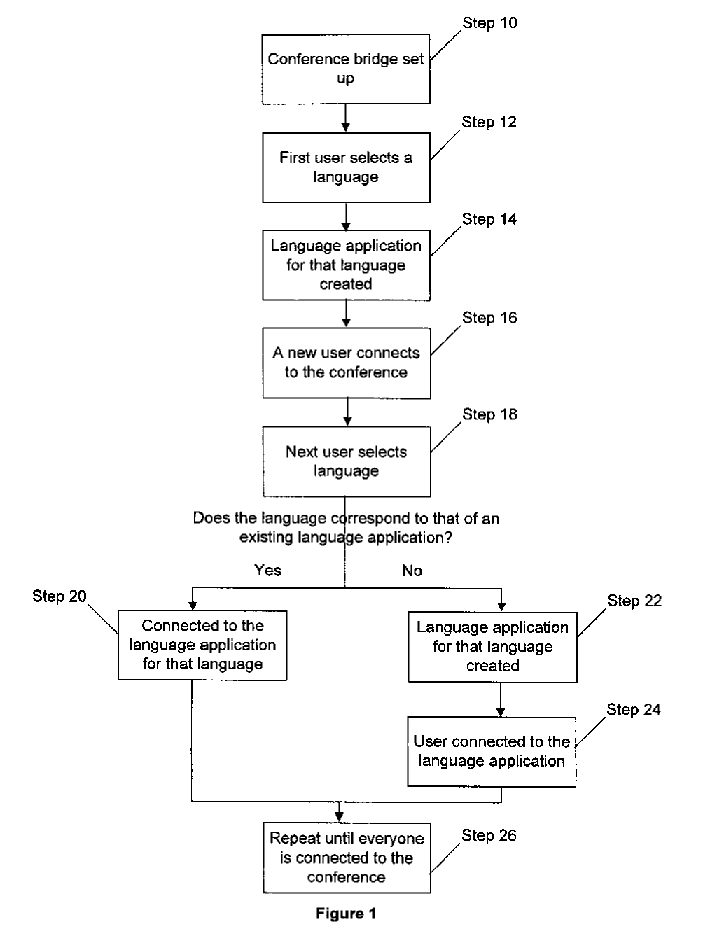

Firstly a conference call is set up as shown in FIG. 1. One user, commonly known as the chairperson, connects to a node within a network using a terminal and creates a conference bridge to which all terminals in the conference will connect using methods known in the art (Step 10). The user on setting up the conference bridge specifies a designated language for the conference. The designated language may be selected from a list using a user terminal (Step 12) or by any other suitable means. In this instance the designated language is English.

The conference bridge then creates a language application (Step 14) specific to the designated language, in this instance English. The language application is adapted to convert data between languages and is implemented by the conference bridge.

Subsequent users join the conference (Step 16) by causing their terminals to connect to the conference bridge. This may be achieved, for example, by dialling a specified number for the conference on the terminal or by any other known mechanism.

When the terminal connects to the conference the user at the terminal must select a language (18), for example English, German, French or any other language. The language may be selected, for example from a list of options, or using any other suitable means. Once the language has been selected the selected language is transmitted to the conference bridge and the conference bridge determines whether the selected language corresponds to that associated with the language application, i.e. the designated language.

If the selected language is the same as the designated language then the terminal is connected to the language application for the designated language (Step 20). This means that any data received by the conference bridge at the terminal is sent to the language application.

If the selected language is not the same as the designated language then the conference bridge searches for a language application for the selected language. If a language application for the selected language has been created and is present on the conference bridge then the terminal is connected to that language application (Step 20).

If no language application for the selected language has been created then the conference bridge creates a language application for that language (Step 22). The terminal is then connected to the language application that has been created.

Once a terminal is connected to a language application any data sent to the terminal by the conference bridge is routed via the language application to which they are connected (Step 24). Conversely, any data transmitted to the conference bridge by the terminal is routed within the conference bridge to the language application to which the terminal is connected.

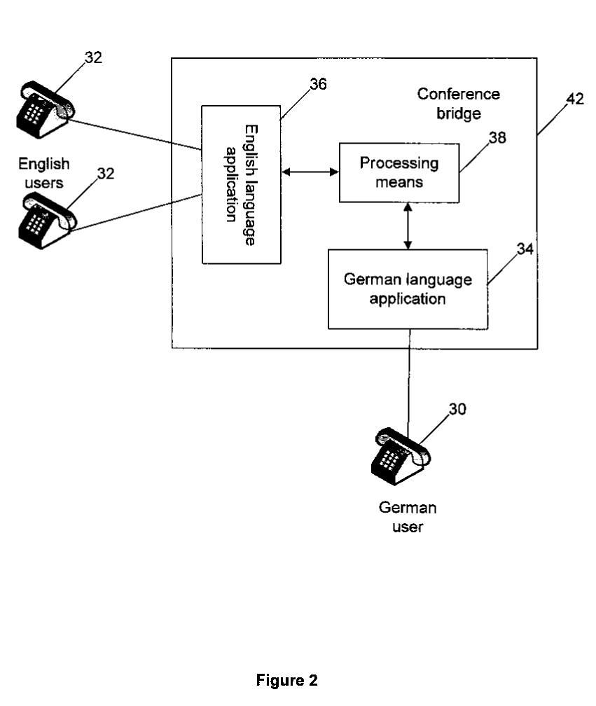

This is repeated until all the terminals in the conference are connected to a conference bridge (Step 26) to create a conference call network as illustrated in FIG. 2.

As can be seen in FIG. 2, the conference includes German and English speakers who are using terminals 30 and 32 respectively. The German 34 and English 36 language applications receive data transmitted by the German 30 and English 32 user terminals respectively. Data is also transmitted between the two language applications. In this embodiment, the language applications 34,36 are situated in the conference bridge 40.

Once the conference is set up with the terminals connected to a language application in the conference bridge, speech transmission across the conference can begin.

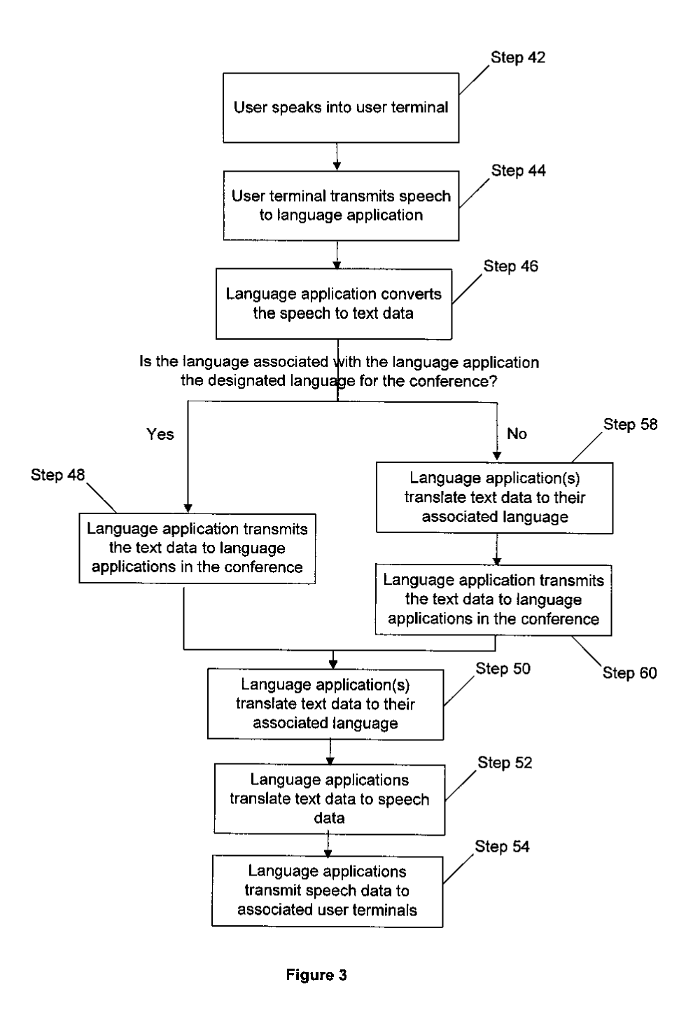

The processing of speech data is described now with reference to FIG. 3 where the designated conference language is English. When a user at a terminal connected to the English language application speaks into the terminal the terminal receives the speech data (Step 42) and transmits it to the English language application in the conference bridge (Step 44).

The English language application upon receiving speech data converts the speech data to text data (Step 46) and transmits the text data to any other language applications that are part of the conference bridge (Step 48).

The German language application, for example, on receiving the text data translates the text data from English to German (Step 50). The German language application then converts the German text data into German speech data (Step 52) and transmits the German speech to each terminal connected to it (Step 54). Once the terminal receives the speech data it can then play it to a user at that terminal.

If the speaking user is speaking German, for example, the use is speaking into a terminal connected to a language application that is not associated with the designated language. In this instance the speech data received by the terminal is transmitted by the terminal to the language application to which the terminal is connected (Step 44).

The German language application, upon receiving speech data from a user terminal, converts the German speech data to German text data (Step 46) and translates the German text data to English text data, the designated language of the conference (Step 48). The English text data is transmitted to all language applications associated with the conference.

A language application, upon receiving the English text data, translates the English text data into text data in the language associated with the language application (Step 50). The text data is then converted to speech data (Step 52) and transmitted to any terminals connected to the language application (Step 54). The English language application does not need to translate the text data prior to converting it to speech data.

If there are multiple language applications in the conference bridge then preferably each language application that is not associated with the designated language is arranged to convert speech data received from user terminals connecting to it to text data and then translate the text data into the designated language prior to transmitting it to the other language application for the conference, as described above. In this way each language application only has to be able to convert between two languages, thereby decreasing the complexity of the system.

Optionally, the conference bridge may be provided with processing means 38. The processing means 38 is arranged to receive text data from language applications and translate received text data in to text data in all the languages of the conference. The processing means then transmits the translated text data to the appropriate language application for conversion to speech data. The language application then transmits the speech data to any terminals connected to it. This negates the need for text data to be translated between languages by language applications.

Preferably, text data that is transmitted within the conference bridge is provided with a tag identifying the original language of the text data. On receiving a message including text data and a tag the language application extracts the tag and analyses it. If the language identified in the tag (i.e. the original language of the data) is the same as the language associated with the language application then the received text data is preferably deleted and the original speech data, which has been stored in a memory, is transmitted to any terminals connected to the language application.

Alternatively, the processing means transmitting text data to language applications identifies that the language application associated with the original language of the speech data and does not transmit the data to that one of the language applications.

The tag may be an identifier for the original language of the application. Alternatively the tag may identify the terminal that transmitted the original speech data or the language application that transmitted the text data. From this information the original language of the data can be determined.

By tagging the data the present invention avoids obvious errors associated with translating a first language into another language and back again. Rather, only the original version of the speech data in the first language is transmitted to terminals of the first language.

The data may be provided with a further tag that enables the language applications to identify the terminal that transmitted the original speech data. The language application prior to transmitting speech data to connected terminals examines the tag and compares the information in it to the identity of terminals connected to the language application. If any of the terminals connected to the language application are identified in the tag then speech data is not transmitted to that terminal. This means that speech data is not transmitted to the terminal from which it was received. Hence, no user hears anything they have spoken into the terminal.

The tag preferably includes the identifier of the terminal from which the speech data was received.

Advantageously, a delay is introduced before any speech data is transmitted to the terminals. This ensures that all the terminals receive the speech at the same time, preventing one group of users hearing, and possibly continuing, the conversation before other groups of users.

The delay time may be of a predetermined duration. For example speech data may only be transmitted to terminals by a language application after a predetermined amount of time has elapsed from the time the original speech data was received from the originating terminal. This may be calculated by a language application that has received speech data transmitting time information with the text data corresponding to the speech data.

Alternatively, transmission of speech data by language application may be delayed until all language applications in the conference bridge flag that a particular portion of text has been translated and converted to speech data. The flag may comprise a message transmitted to all other language applications in the conference bridge. Any other suitable mechanism may be used to ensure that speech data is transmitted to terminals at the same time.

In order for a language application to recognise speech data and convert it to text data accurately the language application preferably generates a speech recognition algorithm that is specific for a particular user. The speech recognition algorithm may be generated every time a user causes a terminal to connect to a conference bridge. Alternatively, the speech recognition algorithm may be stored with user id once it has been generated. This allows the algorithm to be retrieved and used by a language application in a subsequent conference. The algorithm may be stored at the terminal or at any other suitable location within the network from which it can be retrieved.

Preferably, when the speech recognition algorithm is created it is stored in a database with a user id. When the user registers for a conference they may enter the user id in order to enable the algorithm to be located and retrieved.

Optionally, the speech data may be broadcast by the terminals with the acoustic characteristics of the voice of the original speaker so that the voice heard by users resembles that of the original speaker. This may be achieved by generating a voice profile for each user at a terminal and transmitting the voice profile with the speech data in order that it is broadcast by a terminal in a manner that matches the voice profile. Alternatively, the voice profile may be stored in the conference bridge and an identifier for the voice profile transmitted with speech data. The terminal can then access the voice profile using the identifier.

The voice profile may be generated during an initial training session and stored in a database with a user id. The voice profile can then be retrieved and transmitted to all language applications, translation engines or conference bridges connected to the conference when the user registers with a conference and enters the user id. Alternatively, the voice profile may be generated automatically throughout the duration of the conference and voice profile information and updates transmitted with the text data.

As will be understood by one skilled in the art, the speech data may not necessarily be converted into text data but may be converted into any suitable meta-data form. Additionally, depending upon the meta-data form used, the speech data may be converted directly into the meta-data form and the meta-data form may be translated directly into speech data in another language. This removes the need to translate text data from one language to another.

If text data is used as the meta-data form then it may be stored in a memory, for example for use as minutes. The memory may be situated at the main conference bridge for access by a user or, alternatively, situated at another node on the network. Optionally, the text data may be transmitted directly to a terminal which is enabled to display the text data in real time. This may be useful if, for example, a user is deaf.

If text data is not used as the meta-data form then the meta-data may be converted to text data prior to storage in the memory. Alternatively, the meta-data may be stored in the memory.

Any language may be selected to be the designated language, i.e. the language in which the text data is transmitted. The designated language need not necessarily be the language of the user setting up the conference bridge. The designated language may be selected from any suitable means and not necessarily from a list.

Multiple language applications and/or conference bridges may be generated for the same language and located at different nodes within the Internet. This network configuration is particularly useful where multiple terminals separated by large geographical distances are to be connected to the same language application. This means that the speech data is more likely to be transmitted to all terminals, and therefore heard by users, at the same time.

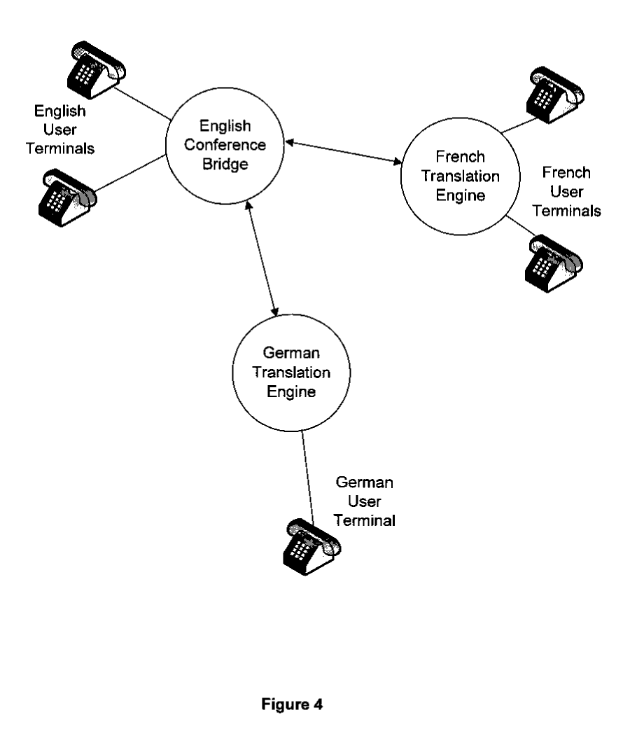

In a second embodiment, illustrated in FIG. 4, the conference bridge and the associated language application for the designated language are created as described with reference to the first embodiment. However, when a further language is specified, for example French, a language application is initiated at a node in the network hereinafter referred to as a translation engine. The translation engine is logically distinct from the conference bridge and may be implemented on the same or a different node as another translation engine.

The translation engine is connected to the conference bridge and the terminals of any users who specify the language associated with the translation engine. For example, the terminals of any users that specify French as the language are connected to the French translation engine. Translation engines are created for every language that is specified by a user at a terminal connecting to the conference.

The translation engine is able to carry out all the functions of the language application of the first embodiment.

When a user using a terminal connected to the conference bridge speaks into their terminal, they will be speaking in the designated language and the speech is transmitted to the conference bridge. The conference bridge converts the speech data to text data and transmits the text data to any translation engines connected to the conference bridge. The translation engines translate any received text data into the language associated with the translation engine. The translation engine then converts the translated text data to speech data and transmits the speech data to any terminals connected to the respective translation engine.

When a user speaks into a terminal connected to a translation engine the speech data is transmitted to the translation engine. The translation engine converts any speech data it receives into text data and then translates the text data into the language associated with the conference bridge i.e. the designated conference language. The translated text data is then transmitted by the translation engine to the conference bridge which transmits the translated text data to any other translation engines that are connected to it.

When the conference bridge receives the translated text data from a translation engine, in addition to transmitting it to any connected translation engine, it converts the translated text data to speech data and transmits the speech data to any terminals connected to the conference bridge. When another translation engine receives the translated text data from the conference bridge it further translates the text data into text data in the language associated with the translation engine. The translation engine then converts the text data it has translated to speech data and transmits the speech data to any terminals connected to the translation engine.

Alternatively, a translation engine may transmit text data corresponding to speech data it has received from a terminal connected to it to the conference bridge without translating the text data to the language associated with the conference bridge.

The conference bridge may then perform the translation of the text data, or alternatively, any translation engine receiving text data may translate the text data prior to converting it to speech data.

In a third embodiment a user at a terminal initiates the conference call as described previously. However, when a user selects a language that is not the designated language a new conference bridge is set up and is associated with the selected language. The new conference bridge is provided with a duplex connection to the main conference bridge.

In a similar manner, when a third language is selected a third conference bridge is created. The third conference bridge, rather than being connected solely to the main conference bridge, is provided with connections to the main and the second conference bridge. For any further languages that are selected new conference bridges are created for each language and are connected to all existing conference bridges within the conference.

Each conference bridge is preferably able to carry out all the features of the language application described in embodiment 1.

In this embodiment, when a user speaks, the terminal transmits speech data to the conference bridge to which the terminal is connected, as described previously. The conference bridge then converts the speech data to text data. The text data is then translated into all the languages associated with conference bridges in the conference, i.e. conference bridges to which the conference bridge is connected. The translated text data is then transmitted to the appropriate conference bridge where it is converted to speech data and transmitted to any terminals connected to the conference bridge.

Alternatively, the conference bridge may transmit the text data in the language associated with that conference bridge and the conference bridge receiving the text data translates the text data prior to converting the text data to speech data and transmitting it to terminals.

As will be understood by the skilled person, the data transmitted in the second and third embodiments may be provided with tags to identify the original language of the text data, and/or the originating terminal of the speech data. Additionally, another meta-data form may be used as an alternative to text data as described with reference to embodiment one. There may be a delay prior to the translation engines and conference bridge transmitting speech data to terminals to ensure that the speech data is transmitted at the same time.

As discussed previously, speech recognition algorithms and voice profiles may be created and stored for each user. Finally, multiple translation engines may be created for the same language. This is useful if multiple terminals, separated by large geographical distances, are to be connected to the same translation engine. If the language of the terminal is the same as that of the conference bridge, an additional translation engine for the designated language may be created.

What is claimed is:

1. Apparatus in a network comprising.
a) a speech receiver to receive speech data in a first language from a transmitter;
b) first translation means to translate the received speech data to meta data:
c) a data transmitter to transmit meta data to the network;
d) a meta data receiver to receive meta data from the network;
e) second translation means to translate meta data to speech data in the first language; and
f) a speech transmitter to transmit data to a receiver unit.

2. Apparatus as recited in claim 1 wherein the speech data is provided with source information.

3. Apparatus as recited in claim 2 wherein the source information includes an identifier comprising at least one of the group comprising a language identity of the language of the speech data as received at the speech receiver and a user terminal identity for the user terminal from which speech data is received by the apparatus.

4. Apparatus as recited in claim 3 wherein the identifier is a language identity, the apparatus further including identification means arranged to determine if the first language is the language identification using the language identity.

5. Apparatus as recited in claim 4 wherein the identification means causes the apparatus to discard the meta data if the language identified in the language identify is the same as the first language.

6. Apparatus as claimed in claim 4 further comprising memory to store speech data received by the speech receiver.

7. Apparatus as recited in claim 6 arranged to cause the speech transmitter to transmit the speech data stored in the memory to user terminals connected to the apparatus.

8. Apparatus as recited in claim 7 wherein the identifier includes user terminal id for the user terminal from which a speech receiver received speech data; the apparatus being arranged to not transmit speech data to a user terminal from which the speech data was received.

9. Apparatus as recited in claim 1 wherein the meta-data is provided with timing information such that speech data is transmitted by the speech transmitter at a predetermined time.

10. Apparatus as claimed in claim 1 wherein the apparatus includes conversion means arranged to convert the meta data to intermediate meta data and transmits the intermediate meta data to the network.

11. Apparatus as recited in claim 1 wherein the apparatus further comprises means for receiving, from a user at a user terminal, a connection request including a language identification and is arranged to determine whether the identified language is the first language.

12. Apparatus as recited in claim 11 wherein apparatus is arranged to receive speech data from a user terminal associated with the first language.

13. Apparatus as recited in claim 11 wherein if the identified language is not the first language, the apparatus connects to a second apparatus comprising
a) a speech receiver to receive speech data in a second language from a transmitter;
b) first translation means to translate the received speech data to meta data;
c) a data transmitter to transmit meta data to the network;
d) a meta data receiver to receive meta data from the network;
e) second translation means to translate meta data to speech data in the second language; and
f) a speech transmitter for transmitting data to a receiver unit.

14. Apparatus as recited in claim 13 wherein the second apparatus is arranged to transmit meta-data to the first apparatus.

15. Apparatus as recited in claim 13 wherein the second apparatus is arranged to transmit meta data to a conference bridge.

16. Apparatus as recited in claim 1 further includes receiving means to receive transmission data from a database arranged to store translation data associated with a user terminal id for translating speech data received from a user terminal to the meta-data.

17. Apparatus as recited in claim 16 wherein the translation data is retrieved from the database when a user terminal having a user id connects to the apparatus.

18. Apparatus as recited in claim 1 wherein the meta-data is text data.

19. A network including a first and second apparatus as claimed in claim 1 wherein the first apparatus is for a first language and the second apparatus is for a second language.

20. A network as recited in claim 19 wherein the first and second apparatus are conference bridges.

21. A network as recited in claim 20 wherein the system further includes a third apparatus as recited in claim 1, the third apparatus being a conference bridge.

22. A network as recited in claim 19 wherein the first and second apparatus are translation engines.

23. A network as recited in claim 22 further including a conference bridge to which the first and second translation engines are connected.

24. A network as recited in claim 23 wherein the conference bridge is arranged to transmit meta-data to the translation engines.

25. A network as recited in claim 24 wherein the conference bridge is arranged to translate the meta-data into intermediate meta-data before transmitting it to the translation engine connected to it.

26. A network as recited in claim 24 wherein the first translation engine is arranged to translate the meta-data form to an intermediate meta-data form before transmitting it to the conference bridge.

27. A network as recited in claim 25 wherein the meta-data is text data.

28. A network as recited in claim 27 wherein the text data is translated from the first language to the second language prior to converting the text data to speech data.

29. A network as recited in claim 26 wherein the meta data is text.

30. A network as recited in claim 29 wherein the text data is translated from the first language to the second language prior to converting the text data to speech data.

31. A method of translating speech comprising:
a) receiving speech data in a first language from a transmitter;
b) translating the received speech data to meta data;
c) transmitting meta data to a network;
d) receiving meta data from the network;
e) translating meta data to speech data in the first language; and
f) transmitting data to a receiver unit.

30. A computer programme arranged to cause apparatus to carry out the steps of:
a) receive speech data in a first language from a transmitter;
b) translate the received speech data to meta data;
c) transmit meta data to a network;
d) receive meta data from the network;
e) translate meta data to speech data in the first language; and
f) transmitting data to a receiver unit.
